(19) United States
(12) Patent Application Publication
(10) Pub. No.: US 2015/0191390 A1
(43) Pub. Date: Jul. 9, 2015

(54) Baseplate

(71) Applicant: UMICORE AG & CO.KG, Hanau (DE)

(72) Inventor: Rudolf Singer, Engelstadt (DE)

(21) Appl. No.: 14/410,149

(22) PCT Filed: Jun. 19, 2013
(86) PCT No.: PCT/EP2013/062730

§ 371 Date: Dec. 22, 2014

(30) Foreign Application Priority Data
Jun. 26, 2012 (EP) 12173696.1

(51) Int. Cl. C03B 37/083; B23K 31/02; C03B 37/09

(52) U.S. Cl. CPC C03B 37/083; C03B 37/09; B23K 31/02

(57) ABSTRACT

The present invention relates to a novel baseplate for bushings, to bushings with these baseplates and to methods for producing the baseplate and the bushings. The baseplate allows differing heating of different portions of the baseplate.

The invention relates to a baseplate for a bushing for producing mineral glass fibres, said baseplate comprising a base area containing a plurality of openings. The invention further relates to a bushing comprising said baseplate.

In the production of glass or mineral fibres in bushings, various difficulties may arise. A stream of liquid glass enters the interior of the bushing through a passage, the temperature of the stream of glass being higher in the middle than at the edge. The stream of glass then meets the baseplate of the bushing and becomes distributed over it. In spite of insulation, a further dissipation of heat to the periphery of the bushing may occur thereby, which in turn may lead to a further cooling of the glass melt at the edges of the baseplate in comparison with the middle. In extreme cases, this may have the effect that the glass melt in the edge regions of the bushing is too viscous and no longer leaves through the nozzles or openings to a sufficient extent to ensure a troublefree spinning process. Since the bushings are heated, e.g. by means of electric current, at the same time as or as an alternative to the effect described above, the glass melt may have such a high temperature in the middle of the baseplate that the viscosity of the glass melt is too low to ensure troublefree production of the fibres. The respective effects are strongly dependent on the individual bushing designs and it is sometimes attempted to overcome them by various measures, which however will have the disadvantage that they merely attempt to compensate for the consequences of the temperature gradient occurring but leave the cause itself unchanged.

It would therefore be desirable to specifically heat the baseplate differently in specific different regions.

The object of the invention may be achieved with a baseplate for a bushing for producing mineral glass fibres, said baseplate comprising a base area containing a plurality of openings, the baseplate having portions with greater or smaller thicknesses than the surrounding portions, and the portions of differing thickness being formed and arranged such that the electrical resistance of these portions is modified in such a way that it brings about differing developments of heat when an electric current is applied, and consequently there is a specific, differing heating of the portions. Preferably, said baseplate is rectangular.

The invention further relates to a bushing which has the inventive baseplate. The portions are appropriately arranged such that the portions that are subjected to high thermal loading during normal operation, i.e. without the use of a baseplate of the present patent application, are heated to a lesser extent when the baseplate of the present patent application is used, and the portions that are subjected to little loading or are too cold during normal operation, are heated to a greater extent.

The openings serve as runout nozzles for the molten material and may be configured as simple holes or by nozzle inserts fastened in such holes.

### BRIEF DESCRIPTION OF THE INVENTION

1. Baseplate for a bushing for producing mineral glass fibres with a, preferably rectangular, base area, which has a plurality of openings, the baseplate having portions with greater or smaller thicknesses than the surrounding portions, and the portions of differing thickness being formed and arranged such that the electrical resistance of these portions is modified in such a way that it brings about differing developments of heat when an electric current is applied, and consequently there is a specific, differing heating of the portions.
2. Baseplate for a bushing for the production of mineral or glass fibres, in particular according to paragraph 1, with a rectangular base area having two longitudinal sides a and two transverse sides b and corners defined by the intersection of said longitudinal sides a with said transverse sides b, said base area having a plurality of openings, the baseplate having a first thickened region in each of the corners, the thicknesses of the first thickened regions being greater than the thickness of the baseplate between the first thickened regions along the transverse sides b.
3. Baseplate according to paragraph 1 or 2, the baseplate having between the first thickened regions along the longitudinal sides a third thickened regions, and the thicknesses of the first thickened regions being less than the thickness of the third thickened regions.
4. Baseplate according to paragraph 1, 2 or 3, the baseplate having in its middle a second thickened region, which has a thickness which is greater than the thickness of the baseplate between the first thickened regions along the transverse sides b.
5. Baseplate according to one or more of paragraphs 1 to 4, the baseplate having in its middle a second thickened region, which has a thickness which is less than the thickness of the third thickened regions along the longitudinal sides a.
6. Baseplate according to one or more of paragraphs 1 to 4, the thicknesses becoming smaller along the transverse sides b between the corners towards the middle.
7. Baseplate according to one or more of paragraphs 1 to 6, the thicknesses becoming greater along the longitudinal sides a between the corners towards their middle.
8. Baseplate according to one or more of paragraphs 1 to 7, the transitions between regions of different thicknesses taking place over intermediate stages.
9. Baseplate according to one or more of paragraphs 1 to 7, the transitions between regions of different thicknesses taking place continuously.
10. Baseplate for a bushing for the production of mineral glass fibres, in particular according to paragraph 1, with a rectangular base area having two longitudinal sides a and two transverse sides b, which has a plurality of openings, the baseplate having parallel to the transverse sides b two first tapered regions, which extend over the length of the two transverse sides, and the thickness of the first tapered regions being less than the thickness of the baseplate between these regions along the longitudinal sides a.
11. Bushing which has a baseplate according to one or more of paragraphs 1 to 10.
12. Method for producing a bushing for the production of fibres from molten mineral material comprising the steps of
a) creating a developed view of a bushing to be produced;
b) producing a one-piece blank from foldable flat material of noble metal that corresponds to the developed view of the bushing;
c) removing or applying material from or to the one-piece blank in order to produce regions of different thicknesses on the baseplate;
d) if appropriate, providing beads;
e) folding the one-piece blank;
f) if appropriate, welding the edges of neighbouring side and end walls or flanges to one another.
13. Method for producing a bushing for the production of fibres from molten mineral material comprising the steps of
a) creating a developed view of a bushing to be produced;
b) producing blanks from foldable flat material of noble metal that together correspond to the developed view of the bushing;
c) removing or applying material from or to the blanks in order to produce regions of different thicknesses on the baseplate;
d) if appropriate, providing beads;
e) if appropriate, folding or bending one or more of the blanks;
f) welding the edges of neighbouring blanks to one another.

### DETAILED DESCRIPTION OF THE INVENTION

This can be brought about for example by the following, specific embodiments. This applies to a baseplate for a bushing for the production of mineral glass fibres with a, preferably rectangular, base area having two longitudinal sides a and two transverse sides b, which has a plurality of openings, the baseplate having parallel to the transverse sides b two first tapered regions (111), which extend over the entire length of the two transverse sides b, and the thickness of the first tapered regions being less than the thickness of the baseplate between these regions along the longitudinal sides a. If this embodiment is used, the tapered regions, that is to say the regions that have a smaller thickness than the thickness of the baseplate therebetween, are heating up to a greater extent than therebetween due to the greater electric resistance of the first tapered regions (111). The width of the tapered regions depends on the width of the regions of the bushing that require increased heating. In the case of many bushings, these are the transverse sides of the baseplate and the corners thereof.

A further embodiment relates to a baseplate for a bushing for the production of mineral glass fibres with a rectangular base area having two longitudinal sides a and two transverse sides b, which has a plurality of openings, the baseplate having a first thickened region (101) in each of the corners, the thicknesses of the first thickened regions (101) being greater than the thickness of the baseplate between the first thickened regions (101) along the transverse sides b; this defines a region (104) of the baseplate between the first thickened regions along the transverse sides b, the thickness of which is less than the thickness of the first thickened regions (101).

In addition, the thicknesses of the first thickened regions (101) may be less than the thickness of the baseplate between the first thickened regions (101) along the longitudinal sides a, thereby defining third thickened regions (103), the thickness of which is greater than the thickness of the first thickened regions (101) and the thickness of the region (104) of the baseplate between the first thickened regions along the transverse sides b.

Furthermore, the baseplate may have in its middle a second thickened region (102), which has a thickness which is greater than the thickness of the baseplate between the first thickened regions (101) along the transverse sides b. The second thickened region (102) may additionally have a thickness which is less than the thickness of the third thickened regions (103). In one particular embodiment of the above baseplate, said baseplate may be formed such that the thicknesses become less along the transverse sides b, between and proceeding from the corners towards the middle of the transverse sides b.

In a further embodiment of the baseplate, the thicknesses may become greater along the longitudinal sides a between and proceeding from the corners towards the middle thereof (of the longitudinal sides a). This reduction of the thicknesses along the transverse sides b and increase of the thickness along the longitudinal sides a must not be understood as meaning that they can only take place in the edge regions of the baseplate, but that they then continue over the entire surface area. In this case, the reduction of the thickness along the transverse sides b and the increase of the thickness along the longitudinal sides a may be superimposed. In the case of these baseplates, the transitions between regions of different thicknesses may take place over one or more, if appropriate step-like, intermediate stages, which is represented in FIGS. 7, 8, 9 and 11, but also continuously, so that the differences in thickness represent a curved surface, which is represented in FIGS. 6 and 12.

In the case of the two embodiments described above, the thickness of the baseplate is usually between 0.5 and 3 mm, often also from 0.7 mm to 2.5 mm or 1 mm to 2 mm. If an ODS (oxide dispersion strengthened) material noble metal, often platinum or platinum alloy, is used, smaller thicknesses of generally 0.5 mm to 2.5 mm may also be sufficient; in the case of normal noble metal alloys, greater thicknesses of 0.7 mm to 3 mm have also proven successful. Like the dimensions of the longitudinal sides a and the transverse sides b, the exact thicknesses depend on the exact design of the bushings. To control the temperature, the thicknesses of a baseplate usually differ by a factor of up to about two. That is to say that, in the case of the baseplate which has a greatest thickness of for example 2 mm, the smallest thickness is usually not less than 1 mm. Such differences in thickness are normally sufficient for controlling the temperature of a bushing baseplate described above of the present patent application during operation.

This embodiment likewise relates to a bushing which has such a baseplate.

Such a bushing may be constructed like the known bushings of the prior art, only the baseplate being formed in the way described here. Apart from the novel baseplate described above, such a bushing has side walls fastened to the longitudinal sides of the baseplate and end walls fastened to the transverse sides. These walls are generally rectangular or square. For fastening and sealing, the bushings may also have flanges. The flanges are metal strips which are fastened to the upper edge of the side and/or end walls and are usually mounted on the bushing substantially parallel to the baseplate. Bushings on which the end walls have a form that is triangular, trapezoidal or trapezoidal with one or two attached rectangles also exist. The cross section of a bushing with such an end wall is depicted for example in the German laid-open application DE 102009051067. This has the advantage that larger baseplates with a greater number of runout nozzles can be obtained. In this case, cover plates may be additionally arranged between the side walls and flanges, fastened to them as depicted in FIG. 13.

Further elements may be attached to the bushing, such as power feeds, supporting or reinforcing parts or the like. Suitable power feeds are described for example in EP 126 8353 and in the documents cited there. Examples of reinforcing and retaining parts are described in EP 144 1993 and the literature cited there.

The bushing and the baseplate may be produced from a flat material of noble metal in order to allow for the high temperatures and the high corrosiveness of molten glass. In a further specific embodiment, the noble metal is selected from the group consisting of gold, iridium, platinum, rhodium and alloys thereof. Particularly suited is a flat material of noble metal, the noble metal being selected from the group consisting of PtAu5, PtIr1, PtRh5, PtRh10, PtRh20, PtIr3, PtIr5, pure platinum and combinations thereof. Particularly well suited is oxide dispersion strengthened (ODS) noble metal. Here, the noble metal is often a noble metal oxide dispersion strengthened (ODS) with one or more oxides, in particular yttrium oxide and/or zirconium dioxide.

Such materials are known in principle and can be obtained for example by the methods that are described in EP 1781830 or EP 1295954.

The baseplate of the bushing may be obtained by working the metal sheet from the starting thickness corresponding to the material chosen. The metal sheet for producing the baseplate is first cut to size—in the same way as the other parts of the bushing. For producing the blank and/or removing material, processes such as milling, water-jet cutting, laser cutting, punching, cutting, sawing, trimming, grinding or combinations thereof are generally used. The cut-to-size parts of the bushing may subsequently be provided with beads or folds, in order to achieve a strengthening of the finished bushing. The bushing parts may be further brought into a desired form by edge bending or three-point bending, if required.

In order to create the regions of different thicknesses of the baseplate, material is removed. The processes mentioned above, in particular trimming, grinding or milling, may generally be used for removing material. The removal of material may in principle be carried out on the upper side, that is to say the side of the baseplate that later lies inside the finished bushing, but also on the underside, that is to say the side that lies on the underside of the bushing, or both sides. If the openings to be provided are supplemented by inserting and welding on nozzle tips, the removal of material on the underside may offer advantages.

The baseplate may subsequently be provided with the required openings. Depending on the design of the bushing, nozzles may be inserted into these openings and welded to the baseplate.

The individual parts are welded to form the finished bushing. Welding may be performed by all suitable processes, such as for example electron-beam welding, laser welding or TIG (tungsten inert gas) welding. These processes may also be used for welding nozzles to the baseplate.

In an alternative configuration, regions of smaller thickness of the baseplates may be created not by removal of material but by application of material for regions of greater thickness. For this purpose, for example, metal sheets may be applied, in this way creating regions with greater thicknesses. Metal sheets may be applied for example by roll-bonding or welding. Similarly, material may be applied by thermal spraying, such as for example cold-gas spraying, but also by other thermal spraying processes. This procedure may be applied in particular when the bushing baseplate is to be provided with a simple surface profile.

A further configuration concerns a bushing folded from a one-piece blank of foldable flat material of noble metal for the production of fibres from molten mineral material with a baseplate and side and end walls attached in one piece in an articulated manner thereto and standing upright, and with flanges respectively attached in one piece to said walls in an articulated manner, the one-piece blank corresponding to the developed view of the bushing and having surface areas for the baseplate, side and end walls and flanges, and neighbouring walls of the bushing being welded if appropriate, and the bushing having a baseplate according to the present patent application as described above. Such bushings are produced by a method for producing a bushing for the production of fibres from molten mineral material comprising the steps of
a) creating a developed view of a bushing to be produced;
b) producing a one-piece blank from foldable flat material of noble metal that corresponds to the developed view of the bushing;
c) removing or applying material from or to the one-piece blank in order to produce regions of different thicknesses on the baseplate;
d) if appropriate, providing beads;
e) folding the one-piece blank;
f) if appropriate, welding the edges of neighbouring side and end walls or flanges to one another.

The removing or applying of material to produce regions of different thicknesses expediently takes place on the region of the blank that corresponds to the baseplate in the finished bushing. Bushings obtained in this way have various advantages with regard to mechanical stability and service life. The patent application also relates to a method for producing a bushing for the production of fibres from molten mineral material comprising the steps of
a) creating a developed view of a bushing to be produced;
b) producing blanks from foldable flat material of noble metal that together correspond to the developed view of the bushing;
c) removing or applying material from or to the blanks in order to produce regions of different thicknesses on the baseplate;
d) if appropriate, providing beads;
e) if appropriate, folding or bending one or more of the blanks;
f) welding the edges of neighbouring blanks to one another.

In this way, a bushing with the baseplate of the patent application is produced by a conventional method, that is the producing and welding of individual sheet-metal parts.

The baseplate is also provided with openings, which may either themselves be used as runout nozzles or serve as a means for receiving nozzle inserts still to be mounted.

### DESCRIPTION OF THE DRAWINGS

a: Longitudinal side
b: Transverse side
100: Baseplate
101: First thickened region
102: Second thickened region
103: Third thickened region.
104: Tapered Region, Region of the baseplate between the first thickened regions along the transverse sides b
105: Transition region
109: Nozzle, Nozzle opening
110: Hole, serving as exit opening
111: First tapered region
200: Baseplate
300: Baseplate
410: Power feed
420: End face
430: Side walls
440: Fastening mounts
450: Cover plates

FIGS. 1 and 2 show an abstract illustration of a rectangular baseplate 100 in a top view and in a perspective view for bushings with two opposing longitudinal sides a and two opposing transverse sides b. The baseplate 100 has two tapered regions 111, which, when using a metal sheet with for example a maximum thickness of 2 mm, should have at the first tapered regions 111 thicknesses of generally 1 mm or more.

FIG. 3 shows the baseplate 100 in a concretized and perspective representation. As partial sections in the plane III a-b in FIGS. 3a and 3b show in this respect, nozzle openings 109 or holes 110 for the exiting of the glass filaments are provided, distributed over the entire extent of the baseplate 100.

FIG. 4 shows an abstract illustration of a rectangular baseplate 200 for bushings with two opposing longitudinal sides a and two opposing transverse sides b.

FIG. 5 shows the baseplate 200 that is shown in FIG. 4 in an abstracted perspective representation and FIG. 6 shows the baseplate 200 in a concretized perspective representation. The baseplate 200 has first thickened regions 101, second thickened regions 102 and third thickened regions 103. Between the first thickened regions 101 there are along the longitudinal sides a the third thickened regions 103. Between the first thickened regions 101 there are along the transverse sides b of the baseplate 200 tapered regions 104. The thicknesses of the first thickened regions 101 are greater than the thicknesses of the regions 104 of the baseplate 200 between the first thickened regions 101 along the transverse sides b. The thicknesses of the third thickened regions 103 are greater than the thicknesses of the first thickened regions 101. The thickness of the second thickened region 102, which is arranged approximately in the middle, is less than the thickness of the third thickened regions 103, but greater than the thickness of the regions 104 of the baseplate 200 between the first thickened regions 101 along the transverse sides b. Nozzles 109 or openings 110 for the exiting of the glass filaments are provided over the entire extent of the baseplate 200.

FIG. 7 shows in an abstracted representation and a perspective view a rectangular baseplate 300 for bushings and FIG. 8 shows, seen in the direction VIII-VIII, the end face of the baseplate 300 in a concretized representation. The rectangular baseplate 300 for bushings has two opposing longitudinal sides a and two opposing transverse sides b. The baseplate 300 also has first thickened regions 101, second thickened regions 102 and third thickened regions 103. Between the first thickened regions 101 there are along the longitudinal sides a the third thickened regions 103. Between the first thickened regions 101 there is along the transverse sides b a tapered region 104 of the baseplate 300. The ratios of thicknesses to one another correspond to those in FIGS. 4 to 6, but the different thicknesses go over into one another in intermediate stages 105.

FIG. 9 shows a graphic representation of the thickness distribution on the scale 20:1 and FIG. 10 shows in this respect the numerical representation of the thickness distribution of a rectangular baseplate for bushings with two opposing longitudinal sides a and two opposing transverse sides b. FIG. 9 has the same thickened regions and the same ratios of the thicknesses to one another as in FIGS. 4 to 6. The different thicknesses go over into one another in stages, but with more stages and finer transitions than shown in FIGS. 4 and 7.

FIG. 11 shows a graphic representation of a baseplate 200 corresponding to FIG. 9, but on the height scale 2:1 and FIG. 12 shows in this respect the perspective concretized view of the baseplate that is shown in FIG. 11. The baseplate 200 has first thickened regions 101, second thickened regions 102 and third thickened regions 103. Between the first thickened regions 101 there are along the longitudinal sides a the third thickened regions 103. Between the first thickened regions 101 there are along the transverse sides b of the baseplate 200 tapered regions 104. The thicknesses of the first thickened regions 101 are greater than the thicknesses of the regions 104 of the baseplate 200 between the first thickened regions 101 along the transverse sides b. The thicknesses of the third thickened regions 103 are greater than the thicknesses of the first thickened regions 101. The thickness of the second thickened region 102, which is arranged approximately in the middle, is less than the thickness of the third thickened regions 103, but greater than the thickness of the regions 104 of the baseplate 200 between the first thickened regions 101 along the transverse sides b. Here, too, the nozzles or openings for the passing through of the glass filaments are indicated by 109 and 110.

FIG. 13 shows a partial view of a bushing in a perspective view and FIG. 14 shows in this respect a longitudinal section in the plane XIV-XIV from FIG. 13 and in this respect in turn FIG. 15 shows a cross section in the plane XV-XV from FIG. 14.

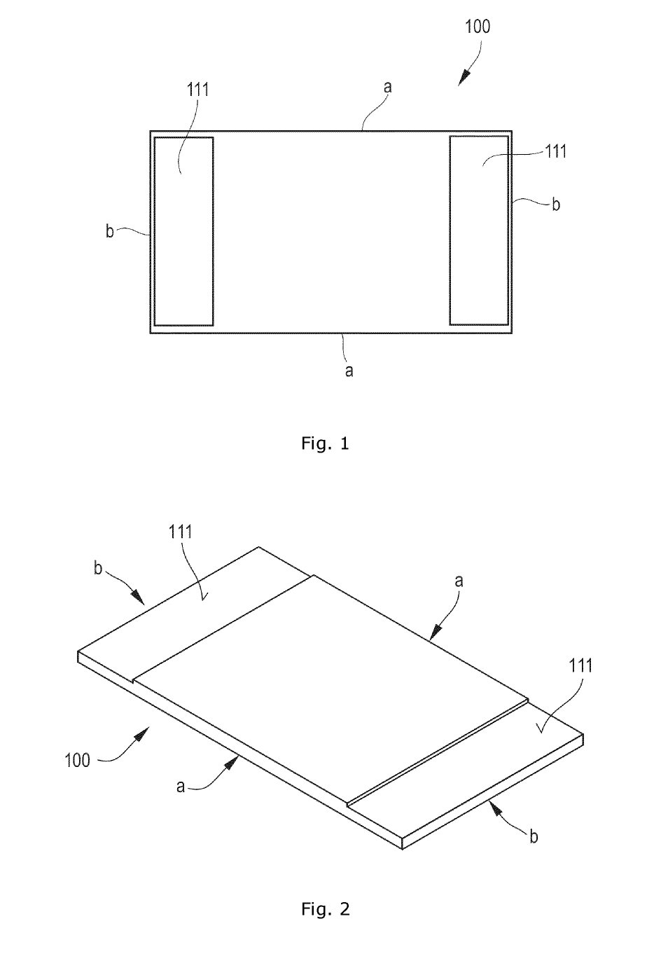

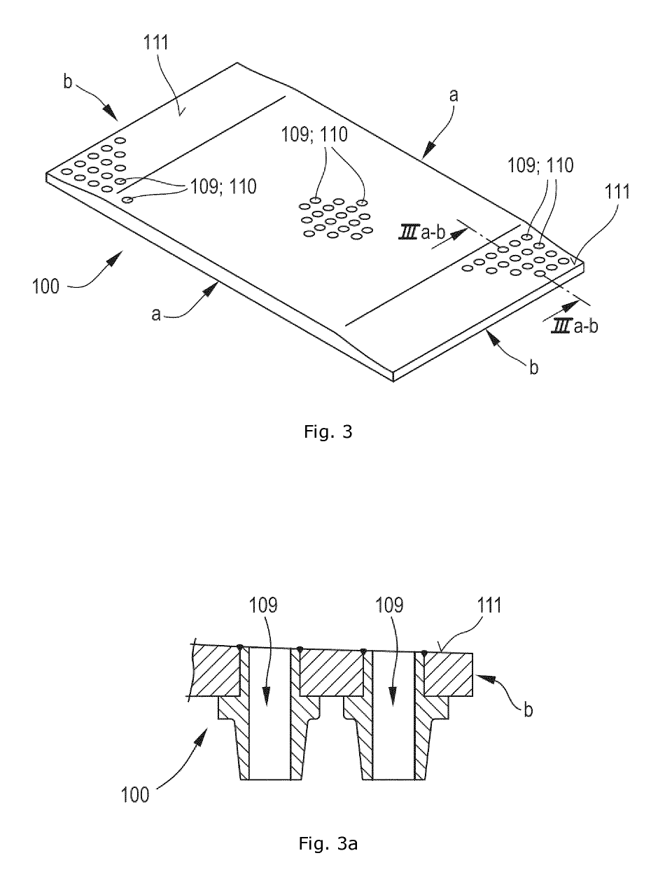

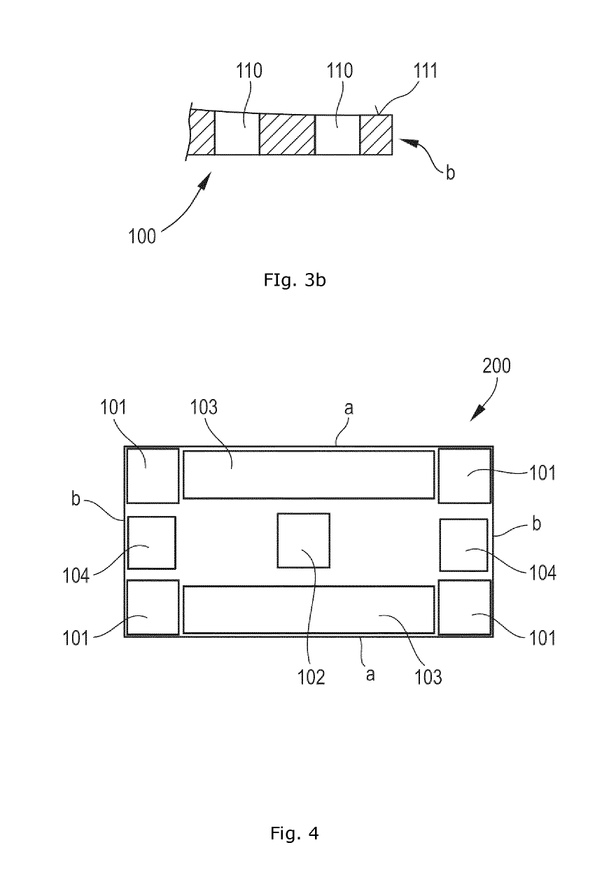

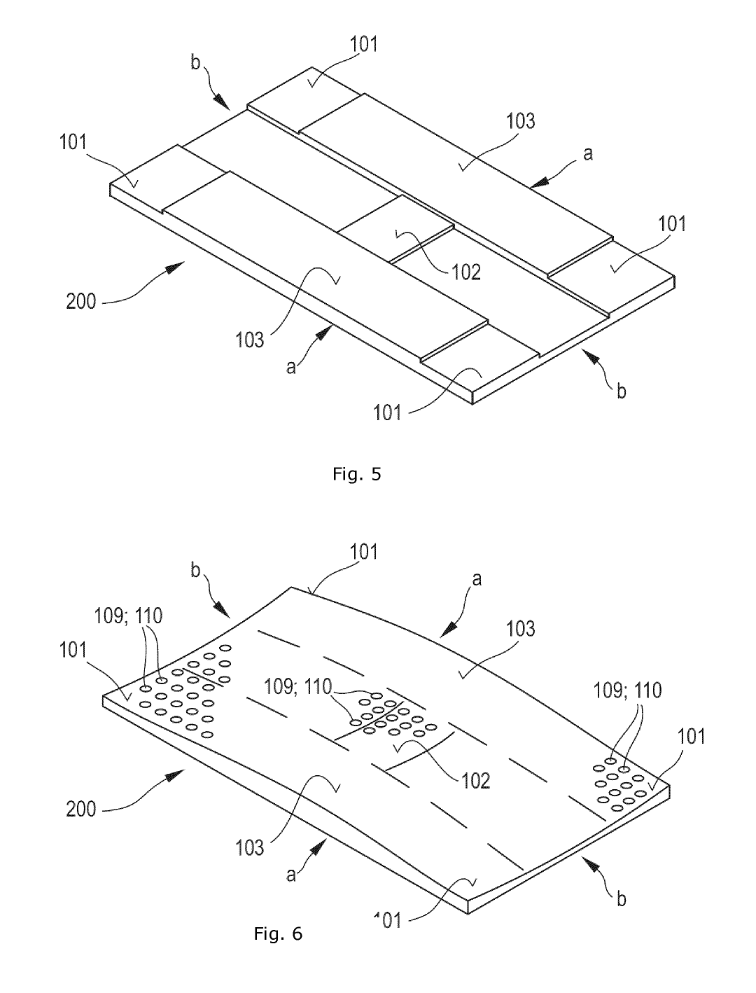

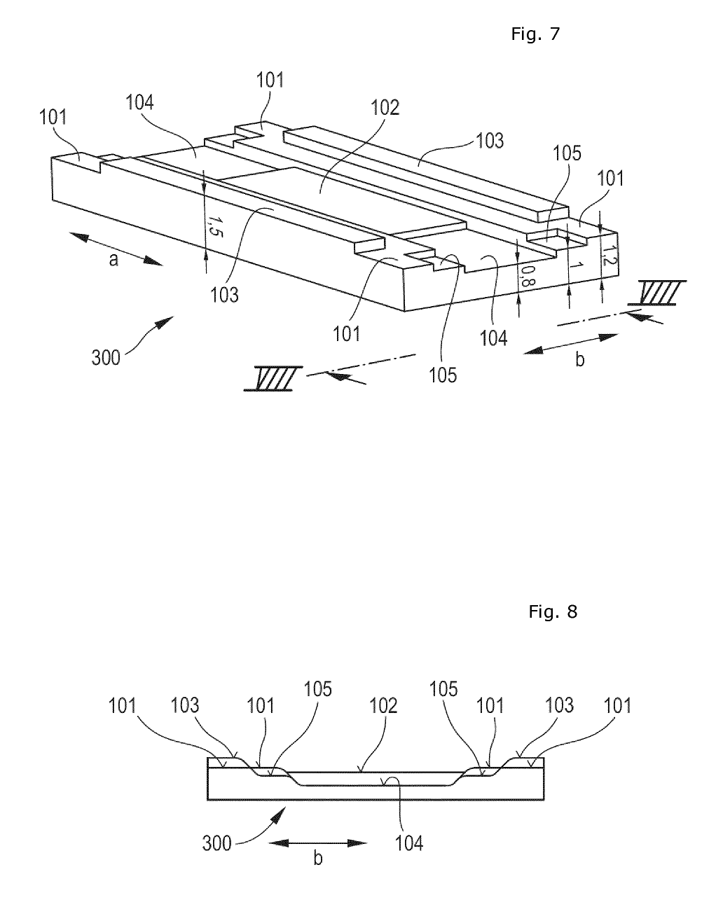

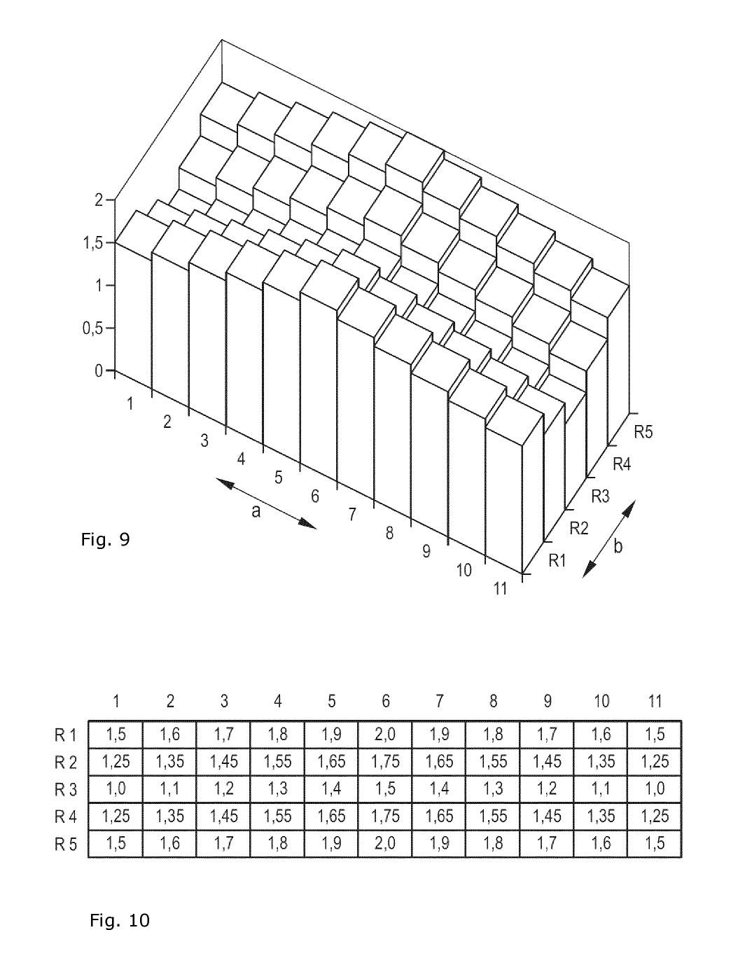

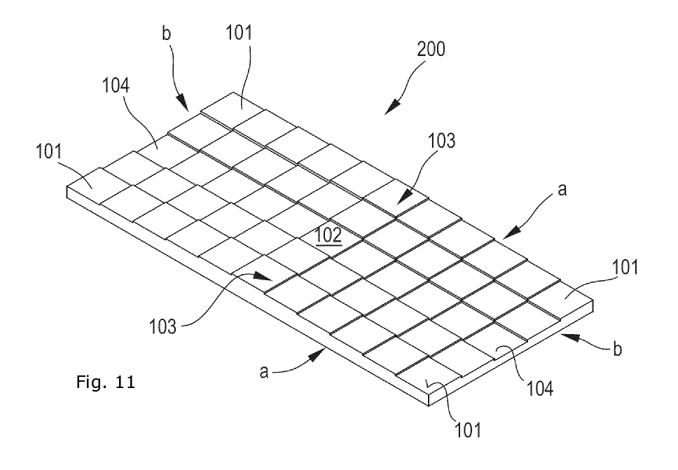

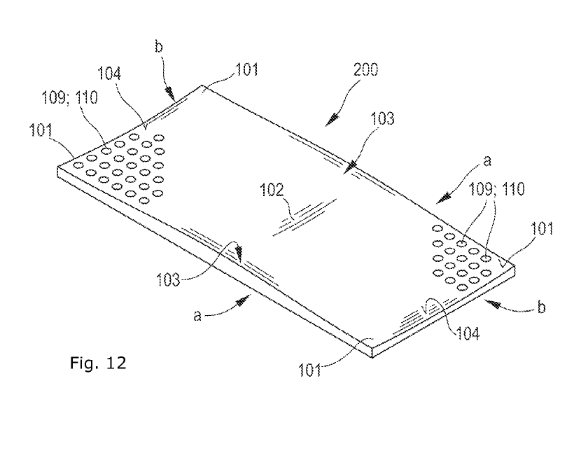

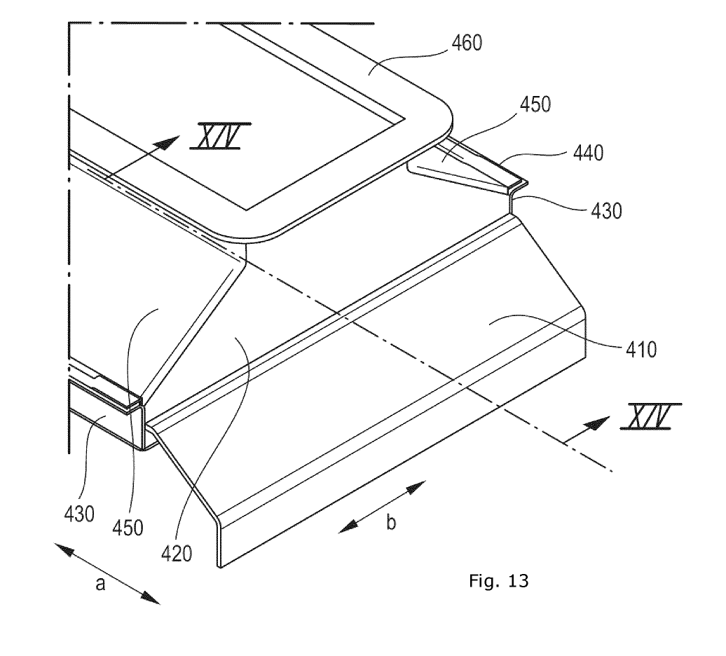

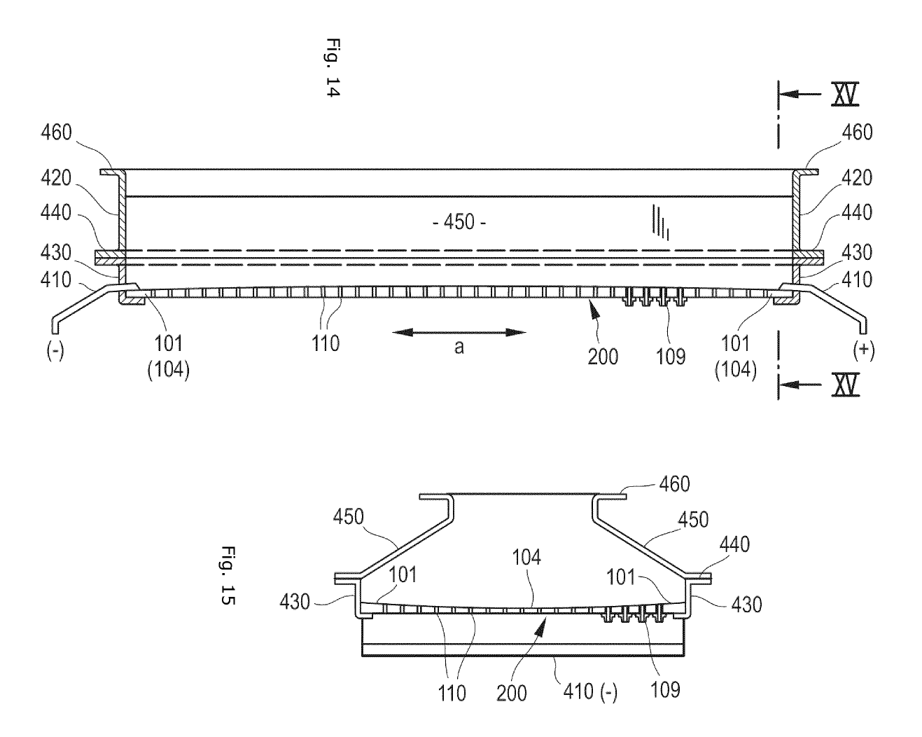

The end face 420 of the bushing partially has a trapezoidal form, whereby the baseplate 200 can be made much larger and can be provided with more runout nozzles 109 or exit openings 110. The bushing depicted has side walls 430, fastening mounts 440, cover plates 450, flanges 460 and a power feed 410.

1-14. (canceled)

15. A baseplate for a bushing for producing mineral glass fibres, said baseplate comprising a base area containing a plurality of openings, the baseplate having portions with greater or smaller thicknesses than the surrounding portions, and the portions of differing thickness being formed and arranged such that the electrical resistance of these portions is modified in such a way that it brings about differing developments of heat when an electric current is applied, and consequently there is a specific, differing heating of the portions.

16. The baseplate according to claim 15, wherein said base area is rectangular.

17. The baseplate according to claim 16, wherein the rectangular base area has two longitudinal sides and two transverse sides and corners defined by the intersection of said longitudinal sides with said transverse sides, said base area having a plurality of openings, the baseplate having a first thickened region in each of the corners, the thicknesses of the first thickened regions being greater than the thickness of the baseplate between the first thickened regions along the transverse sides.

18. The baseplate according to claim 17, the baseplate having between the first thickened regions along the longitudinal sides at least a third thickened region, and the thicknesses of the first thickened regions being less than the thickness of the at least third thickened region.

19. The baseplate according to claim 17, the baseplate having in its middle a second thickened region, which has a thickness which is greater than the thickness of the baseplate between the first thickened regions along the transverse sides.

20. The baseplate according to claim 18, the baseplate having in its middle a second thickened region, which has a thickness which is less than the thickness of the third thickened regions along the longitudinal sides.

21. The baseplate according to claim 17, the thicknesses becoming smaller along the transverse sides between the corners towards the middle.

22. The baseplate according to claim 17, the thicknesses becoming greater along the longitudinal sides between the corners towards their middle.

23. The baseplate according to claim 15, the transitions between regions of different thicknesses taking place over intermediate stages.

24. The baseplate according to claim 15, the transitions between regions of different thicknesses taking place continuously.

25. A baseplate for a bushing for the production of mineral glass fibres with a rectangular base area having two longitudinal sides and two transverse sides, which has a plurality of openings, the baseplate having parallel to the transverse sides two first tapered regions, which extend over the length of the two transverse sides, and the thickness of the first tapered regions being less than the thickness of the baseplate between these regions along the longitudinal sides.

26. A bushing which has a baseplate according to claim 25.

27. A method for producing a bushing for the production of fibres from molten mineral material comprising:
a) creating a developed view of a bushing to be produced;
b) producing a one-piece blank from foldable flat material of noble metal that corresponds to the developed view of the bushing;
c) removing or applying material from or to the one-piece blank in order to produce regions of different thicknesses on the baseplate;
d) optionally, providing beads;
e) folding the one-piece blank;
f) optionally, welding edges of neighbouring side and end walls or flanges to one another.

28. The method of claim 27, further comprising welding edges of neighbouring blanks to one another.
